(19) United States
(12) Patent Application Publication
(10) Pub. No.: US 2008/0048156 A1
(43) Pub. Date: Feb. 28, 2008

(54) Functional film composition for display

(75) Inventors: Duck Ki Ahn, Seoul (KR); Seung-ho Moon, Suwon-si (KR); Tae-jin Jeon, Suwon-si (KR)

Correspondence Address: MCDERMOTT WILL & EMERY LLP, 600 13TH STREET, N.W., WASHINGTON, DC, 20005-3096, US

(73) Assignee: SAMSUNG CORNING CO. LTD.

(21) Appl. No.: 11/878,970

(22) Filed: Jul. 30, 2007

(30) Foreign Application Priority Data
Aug. 2, 2006 (KR) 10-2006-0072863
Jul. 13, 2007 (KR) 10-2007-0070434

(51) Int. Cl. F21V 9/04; F21V 9/06

(52) U.S. Cl. 252/587

(57) ABSTRACT

Disclosed is a functional film composition for a display which comprises an engineering plastic resin, a first pigment absorbing a near-infrared ray; and a second pigment selectively absorbing a wavelength and maintaining thermal stability at a temperature of about 200 through 300° C., thereby exhibiting an excellent electromagnetic wave shielding function in a range of 550 to 610 nm which emits orange light in addition to in a range of 900 to 1200 nm of a near infrared ray, exhibiting a relatively good thermal resistance, moisture resistance, and light resistance in comparison with a conventional transparent plastic film, and exhibiting superior color purity and brightness, so that it can be applied to a PDP filter pursuing good quality, cost reduction, composition of each function, and simplification of structure, and particularly applied to display devices, such as an LCD, an OLED, a flexible display, and the like, pursuing improved optical properties.

### CROSS-REFERENCE TO RELATED APPLICATION

This application claims the benefit of Korean Patent Applications Nos. 10-2006-0072863, filed on Aug. 2, 2006, and 10-2007-0070434, filed on Jul. 13, 2007, in the Korean Intellectual Property Office, the entire disclosure of which is incorporated herein by reference.

### BACKGROUND OF THE INVENTION

1. Field of the Invention

The present invention relates to a functional film for a display, and more particularly, to a functional film composition for a display which exhibits an excellent electromagnetic wave shielding function in a range of 550 to 610 nm emitting orange light in addition to a range of 900 to 1,200 nm of a near infrared ray, exhibits a relatively good thermal resistance, moisture resistance, and light resistance in comparison with a conventional transparent plastic film, and exhibits superior color purity and brightness, so that it can be applied to a Plasma Display Panel (PDP) filter pursuing good quality, cost reduction, composition of each function, and simplification of structure, and in particular, applied to a display device such as a Liquid Crystal Display (LCD), an Organic Light Emitting Diode (OLED), a flexible display, and the like, pursuing improved optical properties.

2. Description of Related Art

As modern society becomes more information oriented, technology of parts and devices related to image displays is remarkably advancing, and these parts and devices are becoming widespread. Display apparatuses utilizing parts and devices related to photoelectronics are becoming significantly widespread and used for television apparatuses, monitor apparatuses of personal computers, and the like. Also, display apparatuses are becoming both larger and thinner. In particular, Plasma display panel (PDP) apparatuses generate a gas discharge between electrodes by a direct current (DC) voltage or an alternating current (AC) voltage which are supplied to the electrodes. Here, ultraviolet light is generated, and then, a phosphor is excited by the ultraviolet light, thereby emitting light. As a result, PDP apparatuses are generally gaining popularity as next-generation display apparatuses to simultaneously satisfy a trend of becoming larger, and of becoming thinner, when compared with cathode-ray tubes (CRTs) representing existing display apparatuses. Also, the PDP apparatuses exhibit superior display characteristics such as display resolution, brightness, contrast ratio, an afterimage, a viewing angle, and the like.

However, the PDP apparatus has a defect in that an amount of emitted electromagnetic (EM) radiation and near infrared (NI) radiation with respect to a driving characteristic is great, and thus, EM radiation and NI radiation generated in the PDP apparatus may have harmful effects on human bodies, and cause sensitive equipment such as wireless telephones, remote controls, and the like, to malfunction. Therefore, in order to use the PDP apparatus, it is required to prevent emission of EM radiation and NI radiation emitted from the PDP apparatus from increasing to more than a predetermined level. In this manner, a filter in which functional films are stacked and positioned on a front surface of the PDP apparatus is referred to as a PDP filter.

Recently, it is required to reduce costs of the PDP apparatus is for consumers due to competition with other competitors. In particular, the PDP filter has a structure obtained by stacking at least four films, which leads to a relatively large proportion of cost of raw materials. Thus, a next-generation PDP filter must be simplified in its structure, and still perform multiple functions.

Also, in the case of an LCD, an OLED, and a flexible display, there is a need for a functional film which can increase color purity and brightness as long as light transmittance and reflectivity of visible rays are not interfered with in terms of increasing of color purity and brightness.

### SUMMARY OF THE INVENTION

An aspect of the present invention provides a functional film composition for a display which has an excellent electromagnetic wave shielding function in a range of 550 to 610 nm which emits orange light in addition to in a range of 900 to 1200 nm of a near infrared ray.

Another aspect of the present invention provides a functional film composition for a display in which a pigment maintaining thermal stability at a temperature of about 200 to 300° C. is used to thereby be prevented from being damaged at the used temperature, and thus, when the pigment is mixed and melted with an engineering plastic resin, the functional film prevents the pigment from being melted by heat.

Still another aspect of the present invention provides a functional film composition for a display which exhibits a relatively good thermal resistance, moisture resistance, and light resistance in comparison with a conventional transparent plastic film, and exhibits superior color purity and brightness, so that the functional film composition can be applied to a PDP filter pursuing good quality, cost reduction, performance of multiple functions, and simplification of structure, and particularly, applied to an LCD, an OLED, a flexible display, and the like, pursuing improved optical properties.

According to an aspect of the present invention, there is provided a functional film composition for a display comprising: a) an engineering plastic resin; b) a first pigment absorbing a near-infrared ray; and c) a second pigment selectively absorbing a wavelength and maintaining thermal stability at a temperature of about 200 to 300°.

According to another aspect of the present invention, there is provided a display filter (a PDP, an LCD, an OLED, a flexible display apparatuses, and the like) to which the functional film for the display is applied.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a graph illustrating durability at a relatively high temperature with respect to a CIR-based pigment according to an exemplary embodiment of the present invention;

FIG. 2 is a graph illustrating light transmittance measured by using a UV-Vis spectrum of a CIR-based pigment according to an exemplary embodiment of the present invention;

FIG. 3 is a graph illustrating durability at a relatively high temperature with respect to a TAP series-based pigment according to an exemplary embodiment of the present invention;

FIG. 4 is a graph illustrating light transmittance measured by using a UV-Vis spectrum of a TAP series-based pigment according to an exemplary embodiment of the present invention; and

FIG. 5 is a graph illustrating a light transmittance of a film for a display according to an exemplary embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

A pigment for selectively absorbing a wavelength has been simultaneously mixed and melted with a plastic resin so as to be disclosed by the present inventors, and as the result, it is certified that when the pigment is mixed and melted with the engineering plastic resin, color coordinates are shown to be constant for each section without losing inherent properties after manufacturing a film, and thus a plastic for a display having multiple functions, such as exhibiting an excellent optical property and shielding a near infrared ray, may be manufactured. In this regard, a functional film for a display of the present invention is disclosed.

The functional film composition for the display according to an exemplary embodiment of the present invention comprises a) an engineering plastic resin; b) a first pigment absorbing a near-infrared ray; and c) a second pigment selectively absorbing a wavelength and maintaining thermal stability at a temperature of about 200 through 300° C. Thus, the second pigment is prevented from being damaged at a relatively high temperature process of about 200° C. As a result, inherent functions of the second pigment are maintained.

A resin for general purposes, which exhibits superior transparency and facilitates in terms of the cost, handleability, weight, and the like, may be used as the engineering plastic resin. Specifically, a polyester-based resin, an acrylic-based resin, a cellulose-based resin, a polyolefin-based resin (polyethylene, polypropylene, copolymer thereof, and the like), a polyvinyl chloride-based resin, a polycarbonate-based resin, a phenol-based resin, and a urethane-based resin may be used as the engineering plastic resin.

In particular, preferably, a polyester-based resin exhibiting a good balance of its thermal resistance and flexibility is used as the engineering plastic resin, more preferably, resins such as polybutylene terepthatlate, polyethylene-2,6-naphthalate, polyethylene terepthatlate (PET), and the like are used, and most preferably, a biaxially oriented polyethylene terepthatlate resin and a polycarbonate resin are used.

The first pigment absorbing the near-infrared ray according to the present exemplary embodiment does not have a particular limitation as to its types, as long as it is a pigment exhibiting maximum absorption in a near-infrared ray region (wavelength of about 800 to about 1,100 nm).

However, in the functional film for the display according to the present exemplary embodiment of the invention, the engineering plastic resin and the first pigment are mixed and melted at a relatively high temperature, and thus, the first pigment whose deformation does not occur at a relatively high temperature of at least 2000 is preferably used. Preferably, a pigment maintaining thermal stability at a temperature of about 200 through 300° C. is used. Also, it is preferable that the first pigment is used which exhibits great absorption for a near-infrared ray region and simultaneously exhibits a relatively high light transmittance in a region of visible rays. Specifically, a diimonium-based compound and a combination thereof with at least one pigment absorbing a near-infrared ray different from the diimonium-based compound are preferably used as the first pigment.

The diimonium-based compound is commercially available, and for example, CIR-1080, CIR-1081, CIR-1083, CIR-1085, and the like, manufactured by Japan Carlit Co., Ltd. are preferably used. Specifically, since the CIR-1080, CIR-1081, CIR-1083, CIR-1085, and the like, whose thermal decomposition starting temperature is about 300° C. or higher do not lose their inherent properties even when being melted with a the engineering plastic resin, they are preferably used.

It is preferable that the first pigment is used in an amount of 2 to 20 parts by weight with respect to 100 parts by weight of the engineering plastic resin. Specifically, there is a problem in that when the amount of the first pigment is less than 2 parts by weight, a near-infrared ray shielding function is significantly deteriorated, and when the amount of the first pigment is more than 20 parts by weight, aggregation of the first pigment occurs in the engineering plastic resin and overall light transmittance is deteriorated.

The second pigment selectively absorbing a wavelength may include a color correction pigment for absorbing neon light in a range of 550 to 610 nm, and a color correction pigment for absorbing light in a range of 470 to 520 nm. The functional film for the display according to the present exemplary embodiment of the invention including the second pigment described above has a light transmittance of 10 to 90% in the above described wavelength regions.

Specifically, a cyanine-based pigment, a polymethine-based pigment, a squarylium-based pigment, a phthalocyanine-based pigment, a quinone-based pigment, an azaporphyrin-based pigment, an azo-based pigment, an azochelate-based pigment, an azlenium-based pigment, a pirillum-based pigment, a croconium-based pigment, an indoaniline chelate-based pigment, an indonaphthol chelate-based pigment, a dithiol metal complex-based pigment, a pyrromethene-based pigment, an azomethine-based pigment, a xanthene-based pigment, and an oxonol-based pigment may be used as the second pigment. In particular, of these second pigments, a pigment maintaining thermal stability at a temperature of about 200 through 300° C. is preferably used, so that the second pigment does not lose its inherent properties even when the second pigment is mixed and melted with the engineering plastic resin.

It is preferable that the second pigment is used in an amount of 3 to 20 parts by weight with respect to 100 parts by weight of the engineering plastic resin. Specifically, there is a problem in that when the amount of the second pigment is less than 3 parts by weight, an absorption function for selective absorbing a wavelength is deteriorated, and when the amount of the second pigment is greater than 20 parts by weight, aggregation of the second pigment occurs in the engineering plastic resin and an overall light transmittance is deteriorated.

The functional film for the display described above according to the present exemplary embodiment of the invention may further comprise d) an ultraviolet absorbing agent in addition to the engineering plastic resin, the first pigment, and the second pigment described above.

Preferably, the ultraviolet absorbing agent has a light transmittance of less than 10% at 380 nm, more preferably, a light transmittance of less than 10% at 390 nm, and most preferably, a light transmittance of less than 10% at 400 nm.

An organic or inorganic ultraviolet absorbing agent may be used as the ultraviolet absorbing agent, and particularly, the organic ultraviolet absorbing agent is preferably used in view of transparency.

An organic ultraviolet absorbing agent well-known to those skilled in the art may be used, and for example, benzotriazole, benzophenone, or cyclic annular iminoester and the like are used alone or in combination with more than two thereof. In particular, the cyclic annular iminoester is preferably used in view of thermal resistance.

It is preferable that the ultraviolet absorbing agent is used in an amount of about 3 to about 30 parts by weight with respect to about 100 parts by weight of the engineering plastic resin. Specifically, there is a problem in that when the amount of the ultraviolet absorbing agent is less than about 3 parts by weight, absorption function of an organic ultraviolet is deteriorated, and when the amount of the ultraviolet absorbing agent is greater than 30 parts by weight, an overall light transmittance is significantly deteriorated.

Hereinafter, of the functional films for the display described above according to the present exemplary embodiment of the invention, a polyester-based film will be described in detail as an example.

In general, either an esterification reaction or an ester exchange reaction is performed with respect to aromatics such as terephthalic acid, isophthalic acid, naphthalene dicarboxylic acid, and the like, and glycol, which are used as the polyester-based film. Subsequently, a polycondensation reaction is performed to thereby obtain a certain material which is typically supplied as a polymer chip type.

Specifically, in the case of the polyester-based film, at least one pigment of the film composition according to the present exemplary embodiment of the invention is mixed and melted with the polymer chip, and is extruded from a T-die into a sheet form, thereby forming a non-drawn film. Next, the non-drawn film is drawn at least uniaxially or preferably biaxially, and then heat-treating, relaxation-treating, and the like, are performed to thereby form the polyester-based film.

As for the drawing method described above, a tubular drawing method, a simultaneously biaxially drawing method, a successively biaxially drawing method, and the like, which are well-known, may be used. The successively biaxially drawing method is preferably used in terms of dimensional stability, planarity, thickness nonuniformity of the film, and the like.

The functional film for the display according to the present exemplary embodiment of the invention may be manufactured in a method which will be described below, however is not limited thereto. Rather, the method should be merely understood as an exemplary example of the present invention.

First, a poly ethylene terephthalate resin pellet is sufficiently vacuum-dried. Next, at least one pigment is simultaneously fed into an extruder together with the pellet, and a melted PET resin of about 280° C. is extruded into a sheet form from the T-die for about 30 minutes. Next, the melted PET resin having a shape of the sheet is allowed to cool and solidify by contacting with a rotary cooling roll according to a static electricity impression method to produce a non-drawn PET film.

The non-drawn PET film is drawn at a draw ratio of about 2.5 to 5.0 times in the longitudinal direction by a roll heated to about 80 to 120° C. to thereby form a uniaxially oriented PET film. Then, the uniaxially oriented PET film is held by a clip at an end thereof and guided to a hot air zone heated to about 70 to 140° C., where the film is drawn at a draw ratio of about 2.5 to 5.0 times in the transverse direction.

The film is further guided to a hot air zone heated at 160 to 240° C., where the film is heat-treated for 1 to 60 seconds. Thus, crystal orientation is completed, thereby obtaining a biaxially oriented PET film having the thickness of 80 to 120 μM.

Otherwise, a polycarbonate film for a display having multiple functions may be obtained by melting and extruding together with a functional pigment in a similar method as the method described above.

In general, “transparency” of a transparent base film designates an overall light transmittance of more than 80%, or preferably more than 90%. Also, a haze of the base film is preferably less than 5%, and more preferably, less than 2%. When transparency of the base film is deteriorated, brightness of the display apparatus and sharpness of the image are deteriorated accordingly. In this instance, the overall light transmittance and the haze are values measured by a method stipulated in JIS-K7136.

Accordingly, as for the film for the display of the present exemplary embodiment obtained by the method described above, a light transmittance must be less than 10% in a range of 850 to 1,100 nm, and must be 30 to 70% in a range of 550 to 610 nm. Also, the film for the display has relatively small microstructural changes caused by a heat, moisture, and light.

A filter for the display (a PDP, an LCD, a flexible display, and the like) to which the functional film for the display described above is applied is provided according to the present exemplary embodiment. The filter for the display prevents a pigment from being melted by a heat when the pigment is melted with an engineering plastic resin, thereby exhibiting an excellent electromagnetic wave shielding function in a range of 550 to 610 nm which emits orange light in addition to in a range of 900 to 1200 nm of a near infrared ray. Also, the filter for the display exhibits a relatively good thermal resistance, moisture resistance, and light resistance in comparison with a conventional transparent plastic film, and exhibits superior color purity and brightness so that the filter can be applied to a PDP, an LCD, an OLED, or a flexible display apparatus pursuing good quality, cost reduction, composition of each function, and simplification of structure.

Hereinafter, the present invention will be described in detail by examples. It is to be understood, however, that these examples are for illustrative purpose only, and are not construed to limit the scope of the present invention.

### EXAMPLES

### Example 1

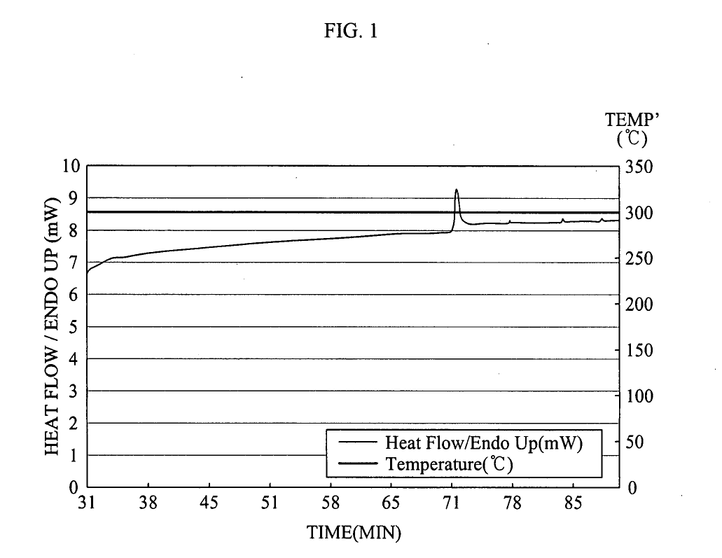

A CIR-based pigment, that is, CIR 1085 (manufactured by Japan Carlit Co., Ltd.) was fed into a differential scanning calorimeter (DSC), durability of the pigment was measured at a relatively high temperature of 300° C. for 30 minutes. As can be seen in FIG. 1, the pigment was melted at the temperature of 300° C. as time passes, however, a relatively great change was not seen for 30 minutes.

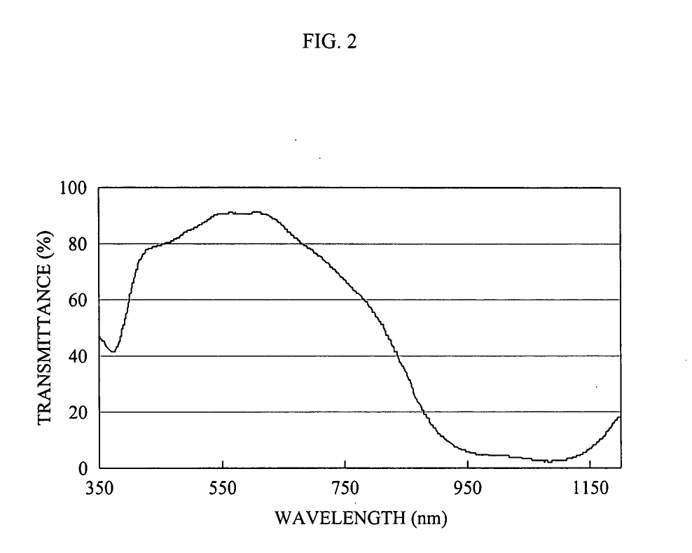

Also, in order to verify whether the pigment can be used after heat-treating, the pigment was left at room temperature for a predetermined time period, and dispersed in organic solvents (MEK, MIBK, toluene, and the like). Next, in order to verify absorption by the pigment for an inherent wavelength of the pigment, transmittance of the pigment was measured by using a spectrum. As can be seen in FIG. 2, light transmittance of the pigment was less than 10% in a range of about 900 to 1,200 nm after heat-treating at the temperature of 300′.

### Example 2

Example 2 was performed in the same manner as Example 1, except that a TAP-based pigment, that is, TAP-2 (manufactured by Yamada Chemical Co., Ltd., Japan) was used instead of CIR 1085 described in Example 1.

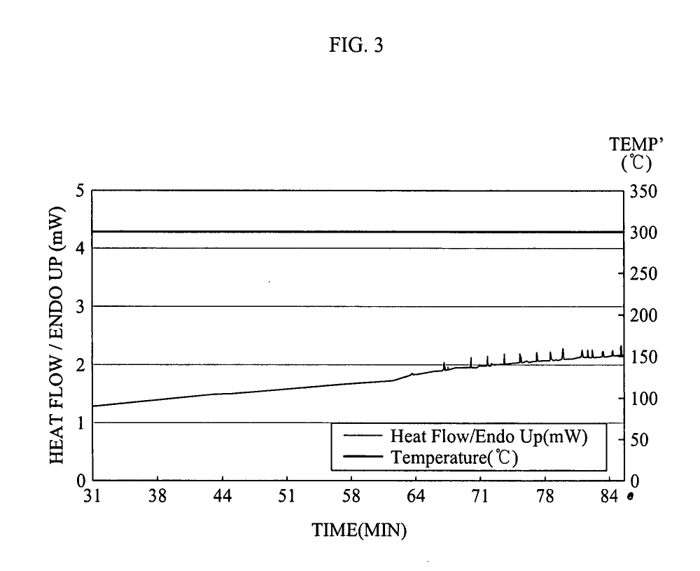

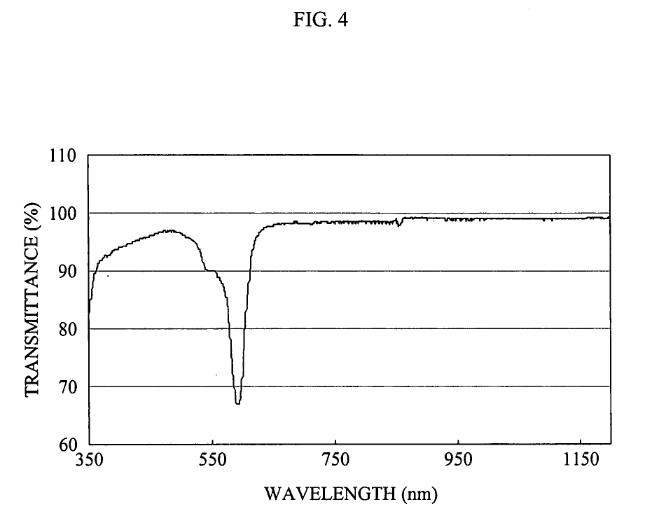

As can be seen in FIGS. 3 and 4, the TAP-based pigment was also melted at the relatively high temperature of 300° C. as time passes, however, a relatively great change was not seen for 30 minutes. It was certified that absorption of the pigment was seen in a range of 580 to 610 nm after heat-treating.

### Example 3

100 parts by weight of a polyethylene terephtalete resin having an inherent viscosity of 0.62 dl/g, 10 parts by weight of a pigment for shielding a near-infrared ray of CIR 1085 (manufactured by Carlit Co., Ltd., Japan), and 8 parts by weight of a TAP series-based pigment (manufactured by Yamada Chemical Co., Ltd., Japan) were fed into a twin screw extruder, melt-extruded from a T-die at a temperature of 280° C. for 30 minutes, and then the extruded sheet was closely adhered to and solidified on a rotary cooling metal roll while applying static electricity to produce a non-drawn sheet.

Next, the non-drawn sheet was heated to 90° C. and longitudinally drawn at a ratio of about 3 to 4 times by using a roll drawing machine. Then an acrylic resin, a melanin resin, and a polyester resin were coated on both surfaces of the longitudinally drawn sheet, so that a coated amount thereof is 0.5 to 1 g/m² after drying, passed through under a condition of wind speed 10 to 15 m/sec, and a relatively hot air at a temperature of 100 to 130° C. for 30 minutes, to thereby form an interlayer. Also, the sheet was heated to 140° C. and transversely drawn at a ratio of about 3 or 4 times by a tender, and subjected to heat-treating while being relaxed with about 5% in the transverse direction at 235° C. to thereby obtain a film, that is, a biaxially oriented PET film including the pigment for shielding the near-infrared ray. The biaxially oriented PET film had a thickness of 100 to 125 μm, and showed an overall transmittance of 82% and an average transmittance of less than 10% in a range of 900 to 1,100 nm.

### Example 4

Example 4 was performed in the same manner as Example 3, except that the TAP-2 was used instead of CIR 1085 described above in Example 3, thereby manufacturing a neon-cut film for a display. The neon-cut film for the display showed that the overall transmittance is 82% and the transmittance was selectively absorbed in a range of 550 to 610 nm.

### Example 5

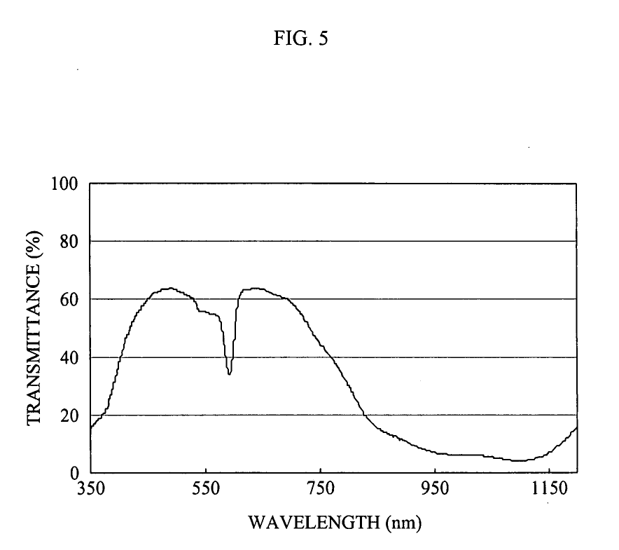

Example 5 was performed in the same manner as Example 3, except that only CIR-1085 was used instead of TAP-2 described above in Example 3, thereby manufacturing a multi-functional film for a display. The multi-functional film for the display showed that the overall transmittance is 55%, and as can be seen in FIG. 5, wavelengths in the range of 550 to 610 nm were selectively absorbed.

As described above, according to the present invention, the filter for the display uses a pigment maintaining thermal stability at a temperature of about 200 through 300° C., so that the pigment is prevented from being melted by a heat when being melted with an engineering plastic resin, thereby exhibiting an excellent electromagnetic wave shielding function in a range of 550 to 610 nm which emits orange light in addition to in a range of 900 to 1200 nm of a near infrared ray. Also, the filter for the display exhibits a relatively good thermal resistance, moisture resistance, and light resistance in comparison with a conventional transparent plastic film, and exhibits superior color purity and brightness, so that the filter can be applied to a PDP, an LCD, an OLED, or a flexible display apparatus pursuing good quality, cost reduction, performance of multiple functions, and simplification of structure.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A functional film composition for a display, comprising:
a) an engineering plastic resin;
b) a first pigment absorbing a near-infrared ray; and
c) a second pigment selectively absorbing a wavelength and maintaining thermal stability at a temperature of about 200 to 300□.

2. The film composition of claim 1, comprising:
a) about 100 parts by weight of the engineering plastic resin;
b) about 2 to about 20 parts by weight of the first pigment; and
c) about 3 to about 20 parts by weight of the second pigment.

3. The film composition of claim 1, wherein the engineering plastic resin comprises at least one resin selected from a group consisting of a polyester-based resin, an acrylic-based resin, a cellulose-based resin, a polyolefin-based resin, a polyvinyl chloride-based resin, a polycarbonate-based resin, a phenol-based resin, and an urethane-based resin.

4. The film composition of claim 1, wherein the first pigment is a diimonium-based compound.

5. The film composition of claim 1, wherein the second pigment is either a color correction pigment for absorbing neon light in a range of about 550 to about 610 nm, or a color correction pigment for absorbing light in a range of about 470 to about 520 nm.

6. The film composition of claim 1, wherein the second pigment comprises at least one pigment selected from a group consisting of a cyanine-based pigment, a polymethine-based pigment, a squarylium-based pigment, a phthalocyanine-based pigment, a quinone-based pigment, an azaporphyrin-based pigment, an azo-based pigment, an azochelate-based pigment, an azlenium-based pigment, a pirillum-based pigment, a croconium-based pigment, an indoaniline chelate-based pigment, an indonaphthol chelate-based pigment, a dithiol metal complex-based pigment, a pyrromethene-based pigment, an azomethine-based pigment, a xanthene-based pigment, and an oxonol-based pigment.

7. The film composition of claim 1, further comprising d) about 3 to about 30 parts by weight of an ultraviolet absorbing agent.

8. The film composition of claim 1, wherein a light-transmittance of the film composition is less than about 10% in a range of about 850 to about 1,100 nm, and is about 30 to about 70% in ranges of about 550 to about 610 nm and about 470 to about 520 nm.

9. A filter for a display device including a functional film for a display, the functional film comprising:
a) an engineering plastic resin;
b) a first pigment absorbing a near-infrared ray; and
c) a second pigment selectively absorbing a wavelength, and maintaining thermal stability at a temperature of about 200 through 300° C.

10. The filter of claim 9, wherein the filter is a filter for a PDP.
